(19) United States
(12) Patent Application Publication
(10) Pub. No.: US 2005/0141956 A1
(43) Pub. Date: Jun. 30, 2005

(54) Device for fastening a part, such as a trough, to a support part, such as a support plate

(76) Inventors: Jean-Pierre Rene Leon, Houilles (FR); Demel Otto, Heidelberg (DE)

Correspondence Address: LEYDIG VOIT & MAYER, LTD, 700 THIRTEENTH ST. NW, SUITE 300, WASHINGTON, DC, 20005-3960, US

(21) Appl. No.: 10/511,087

(22) PCT Filed: Aug. 29, 2003
(86) PCT No.: PCT/EP03/10690

(30) Foreign Application Priority Data
Aug. 30, 2002 (EP) 02 292 147.2

(51) Int. Cl. B25G 3/00

(52) U.S. Cl. 403/256

(57) ABSTRACT

A device for fastening a part, such as a trough, to a support part, such as a support plate, particularly on the edge of a recess on the part. A member includes a fastening member for fastening the part and a clamp that can be swiveled from a neutral position into a position in which one end grips underneath the support part. The clamp can be fastened by a locking screw. The member can be pre-assembled in a captive manner in a receiving profile on the edge of the mounting part.

The invention pertains to a device for fastening a part, such as a trough, to a support part, such as a support plate, particularly on the edge of a recess on said plate, with a member that is provided with a means for being fastened to the part and a clamp that can be swiveled from a neutral position into a position in which one of its ends engages underneath the support part and in which the clamp can be fastened by means of a locking screw.

Known fastening devices of this type have the disadvantage of being bulky and difficult to install. In addition, no adequate means for preventing the fastening device from being lost is provided, and the clamping area is relatively small.

The present invention is based on the objective of developing a fastening device of the aforementioned type in which the aforementioned deficiencies of known devices are eliminated.

The fastening device according to the invention is characterized by the fact that the member can be pre-installed in a captive manner in a receiving profile on the edge of the mounting part.

According to one characteristic of the invention, the part contains a protruding rib with a hole that extends through said rib at least in the region of the member receiving profile, and the member contains a lateral cam-like projection that is inserted into the hole during the pre-installation and can be interlocked on the other side of the hole by turning the member.

According to another characteristic of the invention, the means for holding the member in its locked position consists of an elastic resetting element that is supported on the part and presses the member into its locked position.

According to another characteristic of the invention, the part contains a U-shaped profile at the receiving point of the member, wherein said U-shaped profile is composed of the aforementioned rib with the through-hole and a second rib, and wherein the member is arranged in the space between the ribs and supported on the base of the profile with the elastic resetting element.

According to another characteristic of the invention, the member in the form of a block contains a flat region, on which the clamp in the form of a two-armed lever is supported with its end that cannot be swiveled underneath the support plate.

According to another characteristic of the invention, the member in the form of a block contains a projection, by means of which the member is supported on the free edge of the rib provided with the through-hole in its locked position, namely under the effect of the elastic resetting element.

The invention is described in greater detail below with reference to the enclosed figures that show two embodiments of the invention.

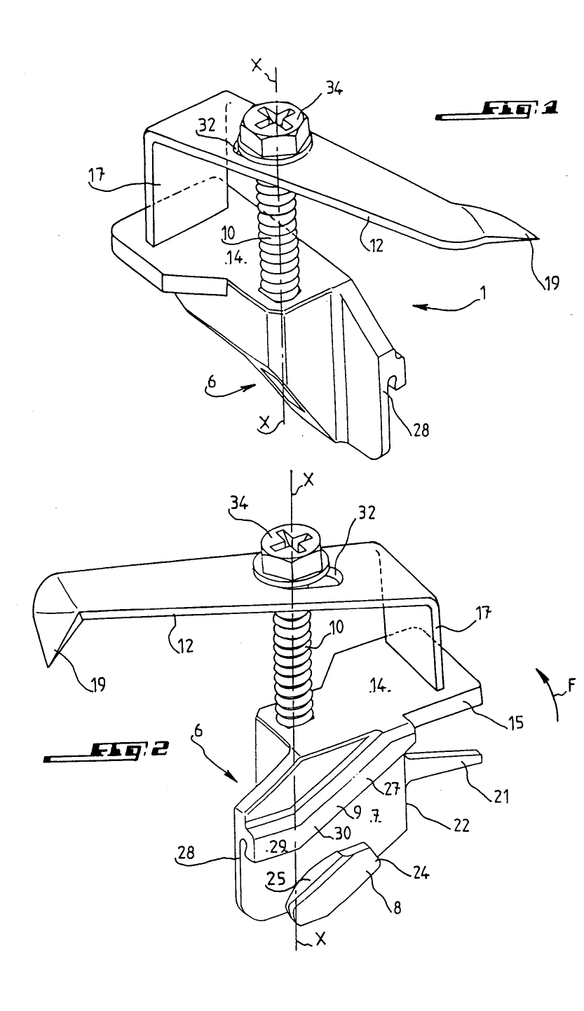

FIGS. 1 and 2 show two different perspective representations of a first embodiment of a fastening device according to the invention;

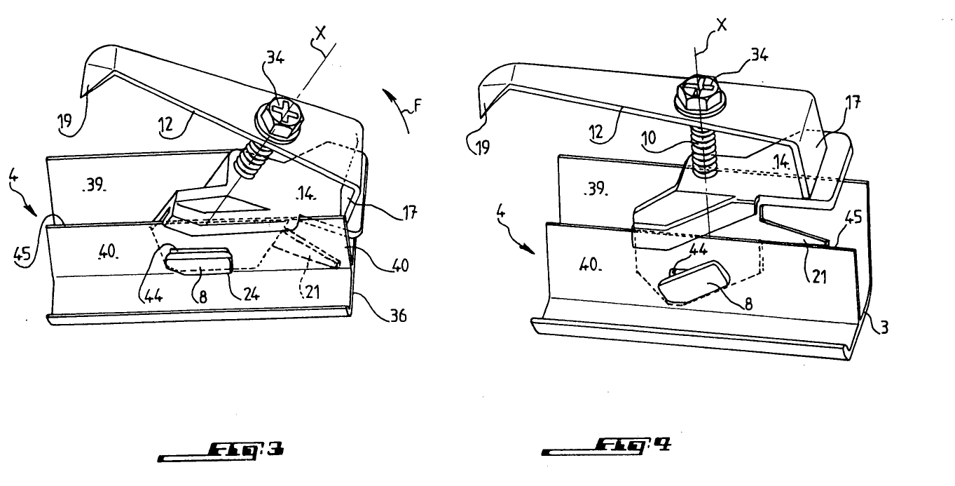

FIGS. 3 and 4 show perspective representations of the fastening device according to FIGS. 1 and 2, wherein the fastening device is positioned and pre-installed on the receiving profile of a part;

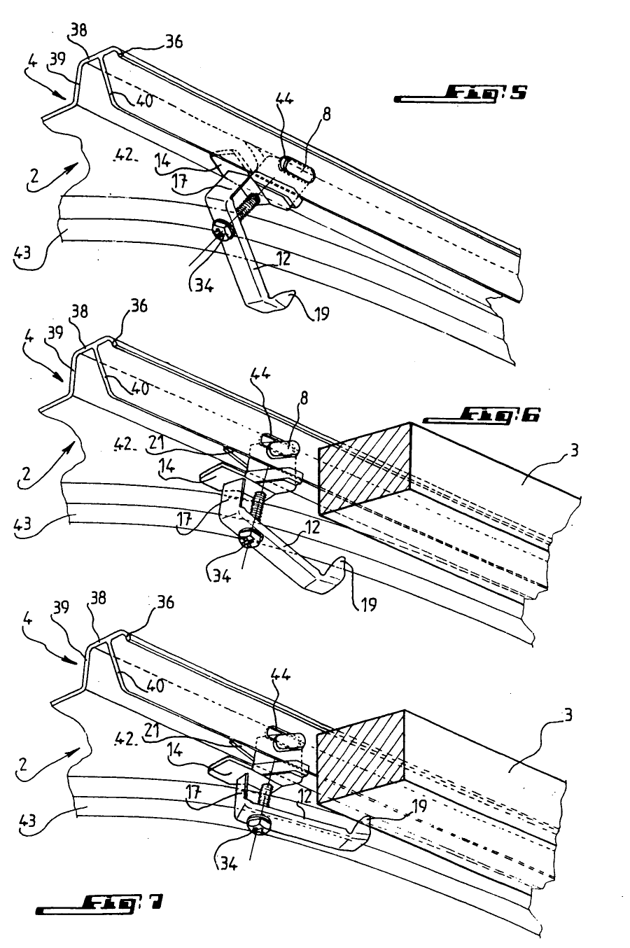

FIGS. 5-7 show perspective representations of the fastening device according to the invention, in a position in which it is attached to a mounting part, wherein the fastening device is pre-installed on the mounting part, inserted into the recess of a support plate and clamped onto the work plate in this position;.

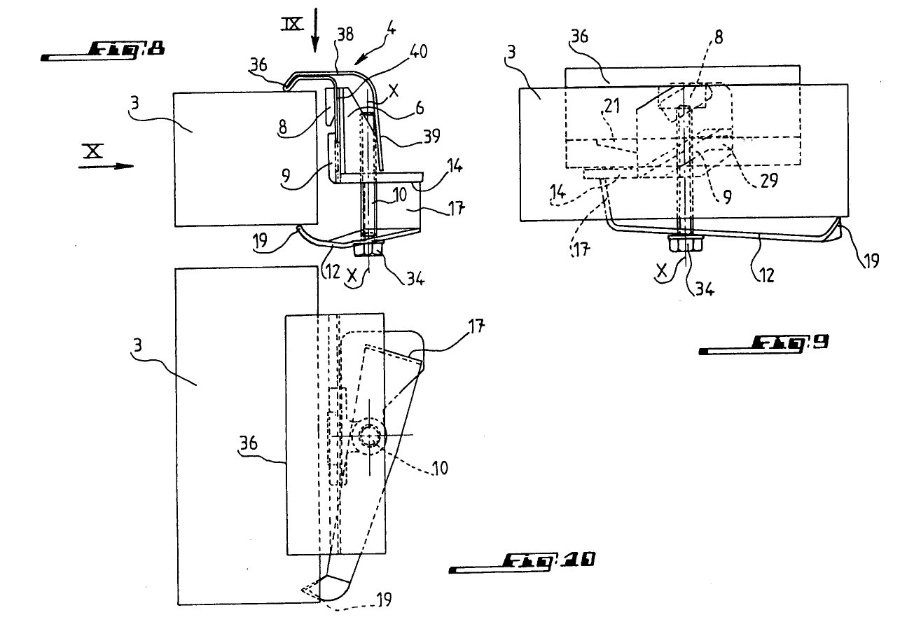

FIG. 8 shows a section through the fastening device according to the invention along line VIII-VIII of FIG. 7;

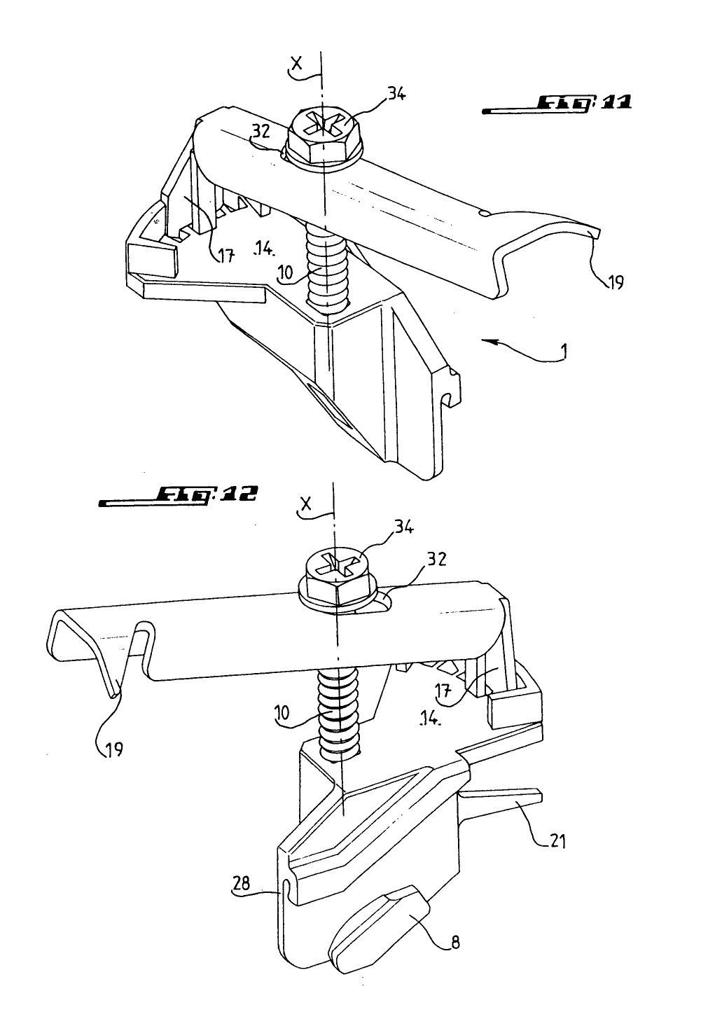

FIG. 9 shows a top view of FIG. 8 in the direction of the arrow IX;

FIG. 10 shows a side view of FIG. 8 in the direction of the arrow X;

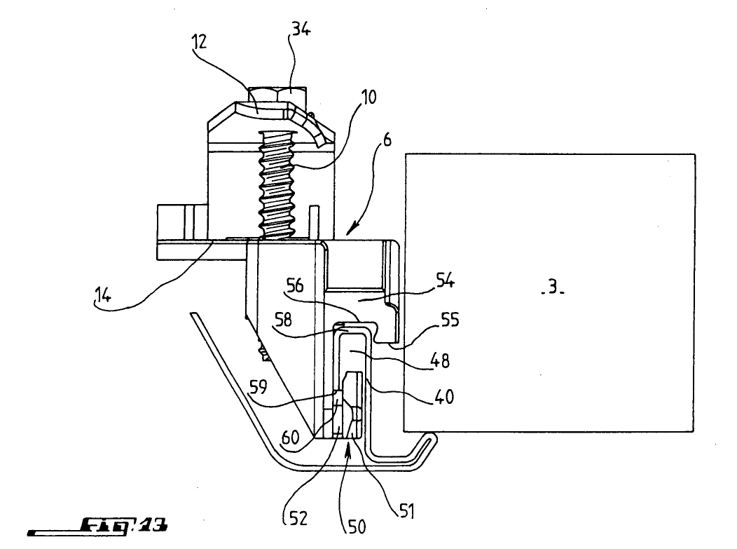

FIGS. 11 and 12 respectively show perspective representations of a different embodiment of the fastening device according to the invention, and

FIG. 13 shows another embodiment of the invention.

FIGS. 1 and 2 show a first embodiment of a fastening device 1 according to the invention for fastening a mounting part 2 on a support plate 3, in the manner illustrated in FIGS. 5-7. In order to fasten the mounting part 2, e.g., in the form of a rinsing trough, onto the work plate 3, the fastening device 1 cooperates with a profile 4 that is arranged on the edge of the mounting part at least in the region in which the device 1 is received. The device 1 and the profile 4 form the fastening device.

FIGS. 1 and 2 clearly show that the fastening device 1 comprises a block-shaped member 6 that preferably consists of plastic, wherein said member is provided with projections 8, 9 on a side surface 7 and a locking or set screw 10 that extends parallel to the longitudinal axis of the block 6. This screw can be screwed into the block and serves for mounting a clamp 12 in the form of a two-armed lever that can be swiveled about the screw.

The screw 10 vertically protrudes from a plane upper surface 14 of the member 16. This surface is laterally extended in the form of a flange region 15 in order to create a support surface for the bent end 17 of the clamp 12. The other end of the clamp carries a laterally oriented claw 19 that extends obliquely downward and serves for engaging underneath the edge of the work plate 3, into which the mounting part is inserted as shown in FIG. 7.

The compact member 6 is also provided with an elastic tab that protrudes from the side surface 22 and extends transversely to the upper surface 14 and the side surface 7. The tab 21 is oriented obliquely downward and arranged such that it generates a resetting force in the direction of the arrow F when the device 1 is installed in its receiving profile 4 on the mounting part 2. The lateral projections 8, 9 on the side surface 7 of the member 6 that extends parallel to the axis X-X form a cam-like projection 8 near the lower end of the member, wherein this projection consists of a flat, oval head section 24 and a neck section 25 of reduced cross section that holds the head section 24 on the member 6. The lateral projection 9 consists of an angled strip 27 that is realized integrally and the free end of which extends essentially parallel to the side wall 7. The latter is laterally extended beyond the vertical outer edge of the block 6 in the form of a flange-like projection 28. The strip 27 has a lower region 29 that extends parallel to the upper surface 14, on which the clamp 12 is supported, as well as a region 30 that is inclined relative to the aforementioned region and extends as far as the surface 14. For reasons of completeness of the description of the device 1, it should also be mentioned that an oblong hole 32 is arranged in the clamp 12, wherein the screw 10 extends through this oblong hole, and wherein the width of said screw is smaller than the diameter of the screwhead 34.

The profile 4 for receiving the fastening device 1 on the edge 24 of the part 4 is realized in U-shaped fashion and comprises a base 38 and two arms 39, 40. The profile also contains a lateral support flange 36 for supporting the mounting part 2 on the edge of the work plate 3 in its installation position (FIGS. 6 and 7). The support flange 36 consists of the lateral extension of the base 38.

It is essential for the function of the inventive device to provide an oval hole 44 5 in the outer arm 40, wherein the longitudinal axis of this oval hole extends parallel to the free edge 45. The hole 44 has a shape that corresponds to that of the oval head 24 of the projection 8 on the block 6 such that the head fits through the hole 44. It is also essential that the width of the U-shaped profile 4 be slightly larger than the width of the compact member 6 of the fastening device 1 in order to insert the member into the 10 channel formed by the U-shaped profile. This is described below with reference to FIGS. 3 and 4. These figures merely show the profile without the edge of the mounting part.

FIG. 3 shows the fastening device 1 in the position in which it is inserted into the U-profile, wherein the head 24 of the cam 8 is already fitted through the hole 44. In 1 5 this position, the free edge of the profile arm 40 engages with the gap 47 formed by the strip 27 and the side wall 7 of the compact member 6. FIG. 3 shows that the axis X-X of the member 6 is inclined relative to the profile in this position. In this inclined position, the elastic tab 21 is deformed because its free end lies on the inner surface of the profile base 38. Thus, the tab 21 deforms in order to fit the cam 8 through the hole 20 44. Once the member 6 is released, the tab presses the member back in the direction of the arrow F. This causes the head 24 of the cam 8 to be turned relative to the hole 44 such that the cam is locked on the other side of the hole. The member is additionally turned until it assumes the position shown in FIG. 4, in which the support surface 14 of the clamp 12 essentially extends horizontally, i.e., parallel to the U-shaped profile, 25 and the free edge of the arm 40 lies on the base of the horizontal region 29 of the gap 47 formed by the integral strip 27 and the side surface 7 of the member 6. In this position, the tab 21 lies on the edge of the arm 40. The head 24 of the cam 8 is locked on the other side of the hole 44 such that the device 1 is captively interlocked in the edge profile 4. Consequently, the position of the fastening device 1 in the edge profile 4 30 according to FIG. 4 can also be referred to as a pre-assembled state, in which the device is captively connected to the mounting part.

The mounting part 2 with the desired number of fastening devices 1 pre-installed in the mounting part profile 4 is inserted into the recess in the support plate 3 as shown in FIG. 6. The clamp 12 is in its neutral position, in which it preferably extends parallel to the profile in order to allow an unhindered insertion of the part 2 into the recess. Since the compact member 6 is primarily situated in the interior of the profile and only protrudes therefrom with the clamp 12 and the surface 14, the additional space required for the fastening device is very small.

In order to fasten the mounting part 2 onto the support plate 3, it suffices to swivel the clamp 12 about the axis of the screw 10 by a corresponding angle, namely until the claw 19 is located underneath the edge of the support plate 3 as shown in FIG. 7. In this position, the angled support end 17 of the clamp 12 still rests on the support plane 14 of the member 10. The clamp 12 is then fixed in this clamping position by tightening the screw 10.

FIGS. 11 and 12 show another embodiment of a fastening device 1 according to the invention. This embodiment merely differs from the embodiment shown in FIGS. 1 and 2 essentially in that the region of the support surface 14 on which the angled support end 17 of the clamp rests is provided with depressions 46 that lie adjacent to one another over the swivel range, making it possible to adjust the swivel angle incrementally. The clamp can be locked into any angular position due to the engagement of the support end 17 in the corresponding depression 46.

Another difference in comparison with the embodiment shown in FIGS. 1 and 2 is that the clamp has a U-shaped cross section and consequently a higher mechanical stability.

The U-shaped cross section also provides the advantage that the screw absorbs part of the pitching moment under load when it laterally joins the arms of the clamp.

FIG. 13 shows another embodiment of the invention, in which the profile 4 of the mounting part consists of a profile without window, i.e., the profile is not provided with a hole 44. In this case, the free end of the arm 40 that is identified by the reference symbol 40′ in this case is perpendicularly bent twice such that an edge 48 with a U-shaped profile is created.

In this case, the block-shaped member 6 contains a lateral projection 50 on its end that lies opposite of the surface 14, wherein said projection consists of a head section 51 and a neck section 52 that holds the head on the member, as well as a projection 54 that is located above the aforementioned projection and integrally formed onto the same side surface of the member. The surface 55 of the projection 54 that lies opposite of the head 51 contains a recess 56 for receiving the base 58 of the U-shaped edge 48 of the profile arm. The cam-like projection 50 and the projection 54 are realized in such a way that, when the block 6 is attached to the profile, the cam 50 engages behind the free end of the U-shaped edge 58 so that the head 50 is able to engage into this edge. When the member 6 is subsequently turned, the neck 52 adjoins the free end of the U-shaped edge 48 with a region 59 and presses this edge into the recess 56 such that the block is fixed on the profile arm 40′ and consequently cannot be lost. The mounting of the profile 4 on the support plate 3 is then carried out as described above.

The previous description explains the advantages of the fastening device according to the invention. One such advantage is the pre-installation of the fastening devices 1 on the edge profile 4 of the mounting part so that the fastening devices cannot be unintentionally lost. Other advantages are the simple and unproblematic assembly, the very small installation space between the mounting part and the work plate as well as the comparatively large clamping area.

These advantages are achieved with the previously described functions, namely the oblique positioning of the fastening device in the receiving profile, the insertion into the hole, the turning and simultaneous interlocking of the part in the profile, the insertion into the recess in the work plate, the swiveling of the claw underneath the work plate and the tightening of the fastening device.

1. A device for fastening a part to a support part, comprising:
a member including means for being fastened to the part;
a clamp that can be swiveled from a neutral position into a position in which an end of the clamp engages underneath the support part; and
locking screw for fastening the clamp, wherein the member can be pre-installed in a captive manner in a receiving profile on an edge of a mounting part of the support part.

2. The device according to claim 1, wherein the receiving profile includes a protruding rib near an edge of the mounting part that lies on the support part, and the member is pre-installed on the rib in a captive manner.

3. The device according to claim 2, including a cam-like projection on a side surface of the member, the cam fitting through a hole in the profile rib and lockable in position at the hole by turning the member relative to the hole, and means for holding the member locked in position.

4. The device according to claim 3, wherein
the means for holding the member locked in position includes a resetting element that can be elastically deformed during insertion of the cam into the hole, and
the resetting element is located on the member and supported on the mounting part.

5. The device according to claim 4, wherein the resetting element includes an elastically deformable tab that protrudes from the member.

6. The device according to claim 4, wherein the receiving profile has a U-shaped profile, one arm of which includes the rib with the through-hole, the member is located in the U-shaped space of the U-shaped profile and supported on the profile by the elastic resetting element.

7. The device according to claim 6, wherein the support zone consists of a surface of an attached part that laterally protrudes over the upper surface of the member.

8. The device according to claim 4, wherein the member includes a lateral projection in the form of a strip spaced from the cam, the strip supporting the member on a free edge of the rib with the through-hole with the member locked in position, by the resetting element.

9. The device according to claim 1, wherein a free edge of the protruding rib has a U-shape, and the member contains lateral projections between which the free edge can be inserted and on which the member can be locked by turning the member.

10. The device according to claim 8, wherein the member includes a support surface on which one end of the clamp including a two-armed lever is supported, and another end having a claw that engages underneath the support part.

11. The device according to claim 10, wherein a support end of the clamp is and the support surface of the clamp is spaced from the strip.

12. The device according to claim 10, wherein the claw includes an end that laterally and obliquely protrudes from the clamp.

13. The device according to claim 11, including locking depressions in the support surface, wherein the support end of the clamp engages with the depressions to fix the clamp in selectable angular positions.
